(19) United States
(12) Patent Application Publication
(10) Pub. No.: US 2007/0061591 A1
(43) Pub. Date: Mar. 15, 2007

(54) User authentication apparatus and user authentication method

(75) Inventor: Takuji Numata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/330,167

(22) Filed: Jan. 12, 2006

(30) Foreign Application Priority Data
Sep. 15, 2005 (JP) 2005-268970

(51) Int. Cl. H04K 1/00

(52) U.S. Cl. 713/186

(57) ABSTRACT

An apparatus performs user authentication based on biological information for organizations. Each organization employs a biological authentication method with a biological authentication device. The apparatus stores thresholds corresponding to the biological authentication methods, acquires a matching degree between registered biological information of a user and biological information read by a biological authentication device employed by any of the organizations, and performs user authentication based on the threshold stored and the matching degree acquired.

### BACKGROUND OF THE INVENTION

1. Field of the Invention

The present invention relates to a technology for authenticating a user by using biological information.

2. Description of the Related Art

There are various biological authentication methods using fingerprints, palm veins, finger veins, irises, and the like. Japanese Patent Application Laid Open No. 2003-67340 discloses an authentication system using a combination of a plurality of biological authentication methods.

However, organizations might employ different biological authentication methods, and therefore, a biological authentication apparatus provided by a certain organization is not always applicable to another organization. For example, when a user withdraws his/her deposit from a bank B by using an ATM of a bank A, and the bank A and the bank B employ different biological authentication methods, the ATM of the bank A is only provided with the biological authentication apparatus for using the method employed by the bank A. Thus, the user cannot use the biological authentication for the bank B.

An ATM to be used for banking transactions for various banks is required to have all the biological authentication apparatuses of all the methods employed by the respective banks. This increases the cost and makes the ATM bulky.

### SUMMARY OF THE INVENTION

It is an object of the present invention to at least solve the problems in the conventional technology.

According to an aspect of the present invention, an apparatus for performing user authentication based on biological information for a plurality of organizations, each of the organizations employing at least one biological authentication method with at least one biological authentication device, includes a storage unit that stores thresholds corresponding to the biological authentication methods employed by the organizations, an acquiring unit that acquires a matching degree between registered biological information of a user and biological information read by a biological authentication device employed by any one of the organizations, and an authentication unit that performs user authentication based on the threshold stored in the storage unit and the matching degree acquired by the acquiring unit.

According to another aspect of the present invention, a method of performing user authentication based on biological information for a plurality of organizations, each of the organizations employing at least one biological authentication method with at least one biological authentication device, includes storing thresholds corresponding to the biological authentication methods employed by the organizations, acquiring a matching degree between registered biological information of a user and biological information read by a biological authentication device employed by any one of the organizations, and performing user authentication based on the threshold stored and the matching degree acquired.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 depicts a financial transaction system using a user authentication apparatus according to a first embodiment of the present invention;

FIG. 2 is a block diagram of the user authentication apparatus shown in FIG. 1;

FIG. 3 depicts an authentication-judging-points storage unit shown in FIG. 2;

FIG. 4 depicts a cash card;

FIG. 5 depicts a converted-points storage unit shown in FIG. 2;

FIG. 6 is a flowchart of processing procedures performed by the financial transaction system shown in FIG. 1;

FIG. 7 is a flowchart of a substitute processing of transaction failure notification processing due to a point shortage;

FIG. 8 is a flowchart of processing procedures performed by the financial transaction system according to the first embodiment when transactions of a plurality of companies are performed at a time;

FIG. 9 depicts group company information;

FIG. 10 is a flowchart of processing procedures performed by the financial transaction system according to the first embodiment when lowest matching degrees are set;

FIG. 11 depicts an example of lowest matching degree information;

FIG. 12 is a block diagram of a user authentication apparatus according to a second embodiment of the present invention;

FIG. 13 depicts thresholds that an authentication judging threshold storage unit stores for each financial institution;

FIG. 14 depicts another example of thresholds that the authentication judging threshold storage unit stores for each financial institution; and

FIG. 15 is a flowchart of processing procedures performed by the financial transaction system according to the second embodiment.

### DETAILED DESCRIPTION OF THE PREFERRED EMBODIMENTS

Exemplary embodiments of the present invention will be described below with reference to accompanying drawings. The present invention is not limited to these embodiments.

In these embodiments, the present invention is applied to transactions with financial institutions such as banks or insurers.

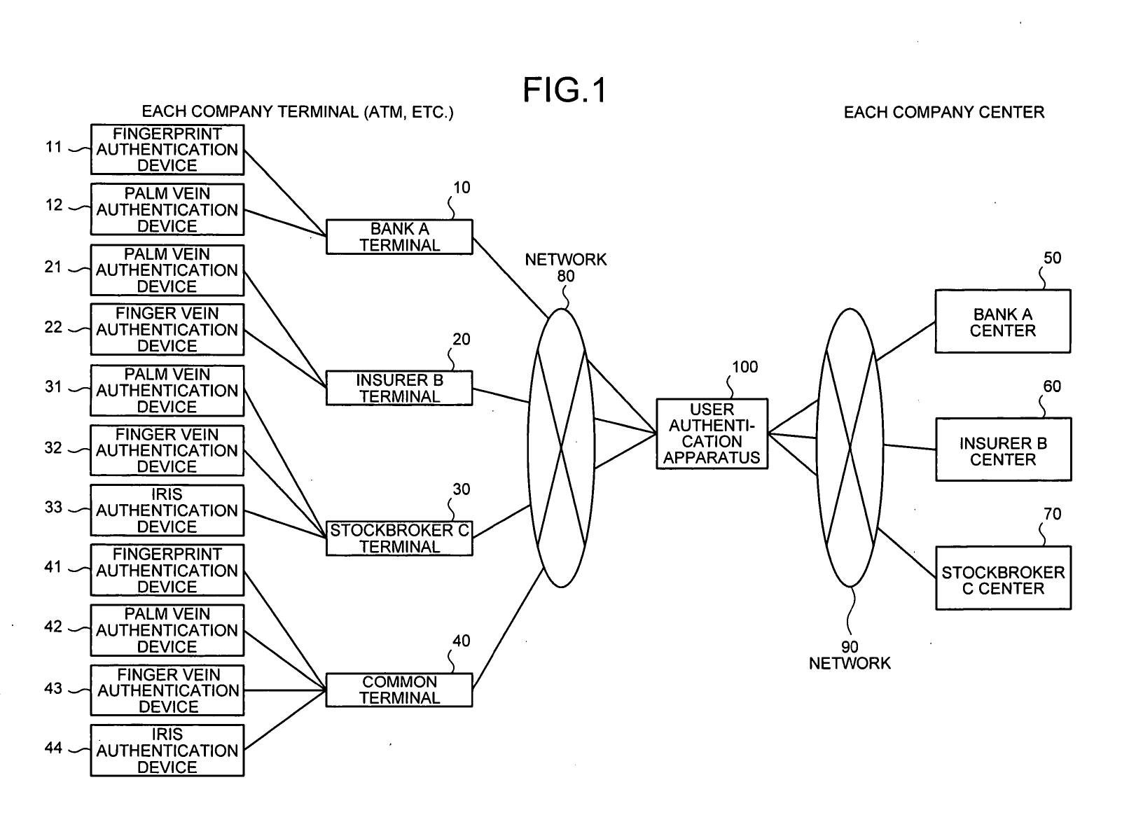

FIG. 1 depicts a financial transaction system using a user authentication apparatus according to a first embodiment of the present invention.

In the financial transaction system, a bank A terminal 10 as facilities of a bank A, an insurer B terminal 20 as facilities of an insurer B, a stockbroker C terminal 30 as facilities of a stockbroker C, and a common terminal 40 that is commonly used by these three companies, are connected to a user authentication apparatus 100 via a network 80.

Herein, the bank A terminal 10 has a fingerprint authentication device 11 and a palm vein authentication device 12. The bank A employs fingerprint and palm vein authentications as biological authentication methods. The insurer B terminal 20 has a palm vein authentication device 21 and a finger vein authentication device 22. The insurer B employs palm vein authentication and finger vein authentication as biological authentication methods.

The stockbroker C terminal 30 has a palm vein authentication device 31, a fingerprint authentication device 32, and an iris authentication device 33. The stockbroker C employs palm vein authentication, finger vein authentication, and iris authentication as biological authentication methods. The common terminal 40 has a finger print authentication device 41, a palm vein authentication device 42, a finger vein authentication device 43, and an iris authentication device 44 so as to adapt to all the biological authentication methods employed by the bank A, the insurer B, and the stockbroker C.

The user authentication apparatus 100 receives matching degrees of biological information of a user from the terminals via the network 80, and authenticates the user based on the matching degrees. The user authentication apparatus 100 is connected to a bank A center 50, an insurer B center 60, and a stockbroker C center 70 via a network 90, and allows a user who has been correctly authenticated to transact with the financial institution by relaying communications between the center and terminal of the financial institution.

The user authentication apparatus 100 enables biological authentication using a biological authentication method that is not employed by a certain financial institution. For example, when a user transacts with the bank A from the insurer B terminal 20, although the bank A does not employ finger vein authentication as a biological authentication method, the user can use the finger vein authentication device 22 as a biological authentication device. Likewise, when a user transacts with the bank A from the common terminal 40, although the bank A does not employ iris authentication as a biological authentication method, the user can use the iris authentication device 44 as a biological authentication device.

Thus, the user authentication apparatus 100 according to the first embodiment enables authentication using a biological authentication device of a biological authentication method that is not employed by a certain financial institution, so that the user can make a financial transaction with the certain financial institution from a terminal of another financial institution by using the biological authentication device of another method.

Furthermore, even when a user cannot use authentication of a biological authentication method employed by a certain financial institution due to an injury or the like, the user can transact with the financial institution by using another biological authentication device such as the terminal of another financial institution or the common terminal.

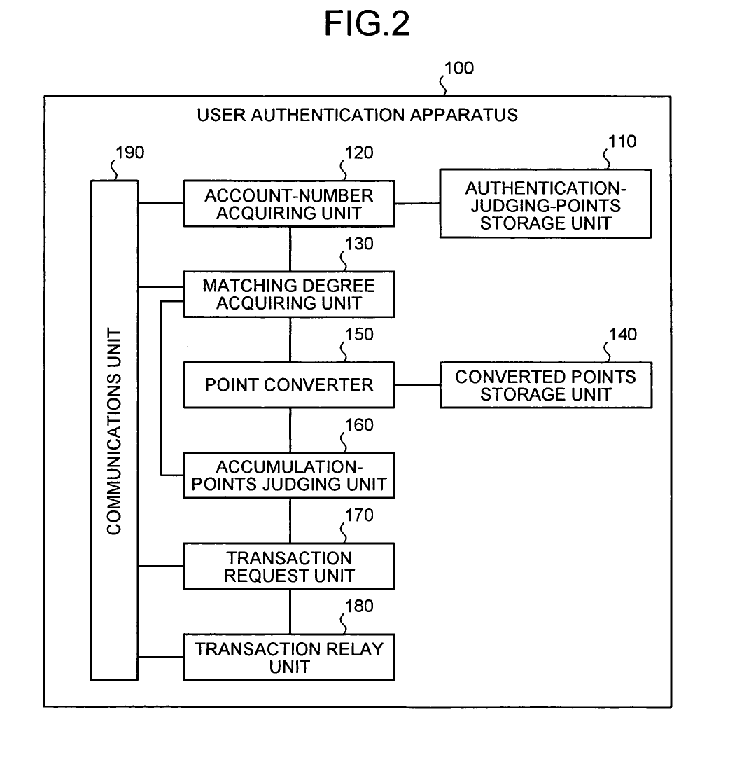

FIG. 2 is a block diagram of the user authentication apparatus 100. The user authentication apparatus 100 includes an authentication-judging-points storage unit 110, an account-number acquiring unit 120, a matching-degree acquiring unit 130, a converted-points storage unit 140, a point converter 150, an accumulation-points judging unit 160, a transaction request unit 170, a transaction relay unit 180, and the communications unit 190.

The authentication-judging-points storage unit 110 stores reference points, that is, thresholds for authentication judgement for each financial institution. A biological authentication device acquires a matching degree when authentication is performed. A point is a value converted from the matching degree. The user authentication apparatus 100 does not perform authentication by using the matching degree as it is, but performs authentication by converting a plurality of matching degrees obtained from a plurality of biological authentication devices into points and using the total points.

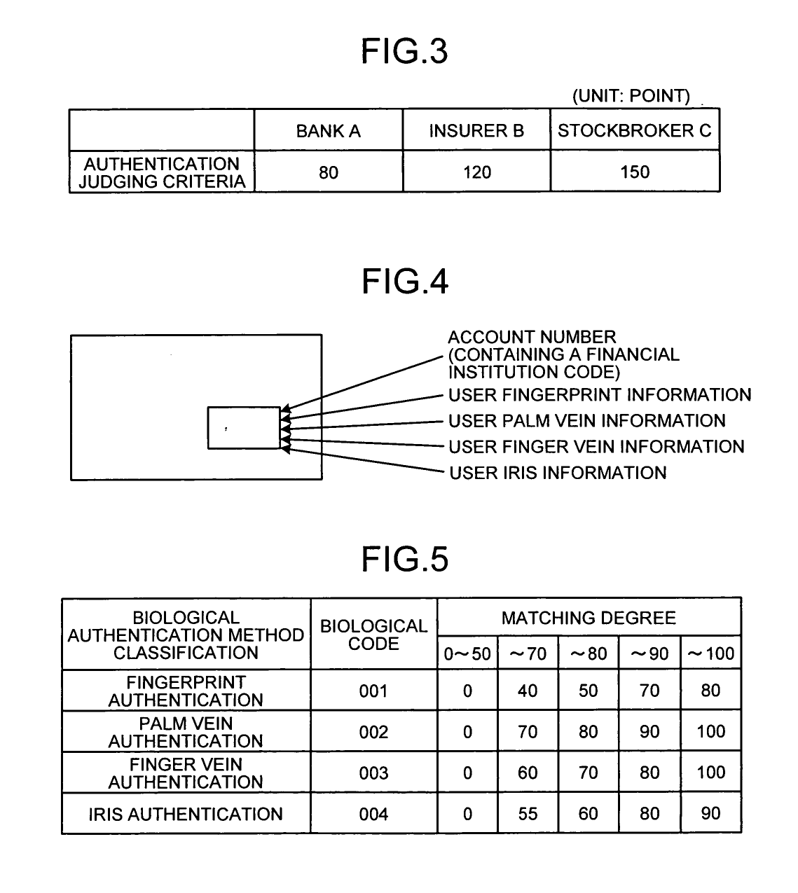

FIG. 3 depicts the authentication-judging-points storage unit 110. The authentication-judging-points storage unit.110 stores thresholds for authentication judgement as authentication judging criteria for each financial institution. For example, the bank A judges that user authentication is successful when the total points converted from a plurality of matching degrees is 80 or more.

The account-number acquiring unit 120 acquires an account number read by a terminal from a cash card. The account-number acquiring unit 120 acquires an account number containing a financial institution code from a cash card, reads an authentication judging criterion of the financial institution from the authentication-judging-points storage unit 110 based on the financial institution code, and sets the criterion as authentication judging points to be used for authentication judgement.

The matching-degree acquiring unit 130 instructs a terminal from which the account-number acquiring unit 120 has received an account number to read biological information by using a biological authentication device, and to transmit a biological code for identifying the biological authentication method used and a matching degree. Upon receiving the biological code and matching degree transmitted from the terminal, and matching-degree acquiring unit 130 delivers these to the point converter 150.

FIG. 4 is a diagram of an example of a cash card. As shown in the figure, the cash card is an IC card including an IC storing user fingerprint information, user palm vein information, user finger vein information, and user iris information as user biological information, together with an account number. Each terminal compares information read by each biological authentication device and user biological information stored in the cash card and transmits a matching degree between these to the user authentication apparatus 100.

FIG. 5 depicts the converted-points storage unit 140 that stores points converted from matching degrees. The converted-points storage unit 140 stores, for each biological authentication method, a biological authentication method classification, a biological code identifying a biological authentication method, and points converted from a matching degree.

For example, in fingerprint authentication, the biological code is 001, and the point becomes 0 when the matching degree is equal to or less than 50, the points become 40 when the matching degree is more than 50 and equal to or less than 70, the points become 50 when the matching degree is more than 70 and equal to or less than 80, the points become 70 when the matching degree is more than 80 and equal to or less than 90, and the points become 80 when the matching degree is more than 90 and equal to or less than 100.

Even when the matching degree is the same, if the authentication method is different, the points become different. For example, the points become 70 at a matching degree of 70 in palm vein authentication, and on the other hand, the points become 60 even at the matching degree of 70 in finger vein authentication. The reason for this is that accuracy of the matching degree differs among authentication methods, that is, for example, palm vein authentication has a wider permissible range in authentication and performs authentication more accurately than finger vein authentication. Accordingly, the accuracy differences among authentication methods are absorbed by converting the matching degrees into points so that various biological authentication methods can be used.

The point converter 150 refers to the converted-points storage unit 140 by using the biological code and the matching degrees acquired by the matching-degree acquiring unit 130, converts the matching degrees into points, and delivers the converted points to the accumulation-points judging unit 160. The point converter 150 converts matching degrees into points by referring to the converted-points storage unit 140, whereby differences in matching degree accuracy among authentication methods are absorbed so that authentication using a combination of the authentication methods can be performed.

The accumulation-points judging unit 160 receives points from the point converter 150 and accumulates the points, and judges whether the accumulation points are equal to or more than authentication judging points set by the account-number acquiring unit 120. When the accumulation points are equal to or more than the authentication judging points, the accumulation-points judging unit 160 judges that user authentication is successful, and instructs the transaction request unit 170 to request transaction. When the accumulation points are not equal to or more than the authentication judging points, the accumulation-points judging unit 160 judges that user authentication is unsuccessful, and notifies the terminal of a necessity of biological authentication by using another biological authentication device via the matching-degree acquiring unit 130.

The transaction request unit 170 notifies a center of a financial institution corresponding to the account number of the successful authentication and requests start of a transaction. The transaction relay unit 180 relays communications between the terminal and the center.

The communications unit 190 communicates with the terminal via the network 80 and communicates with the center via the network 90, and for example, receives an account number and a matching degree from the terminal and transmits an instruction to the terminal to transmit a matching degree of another biological authentication device.

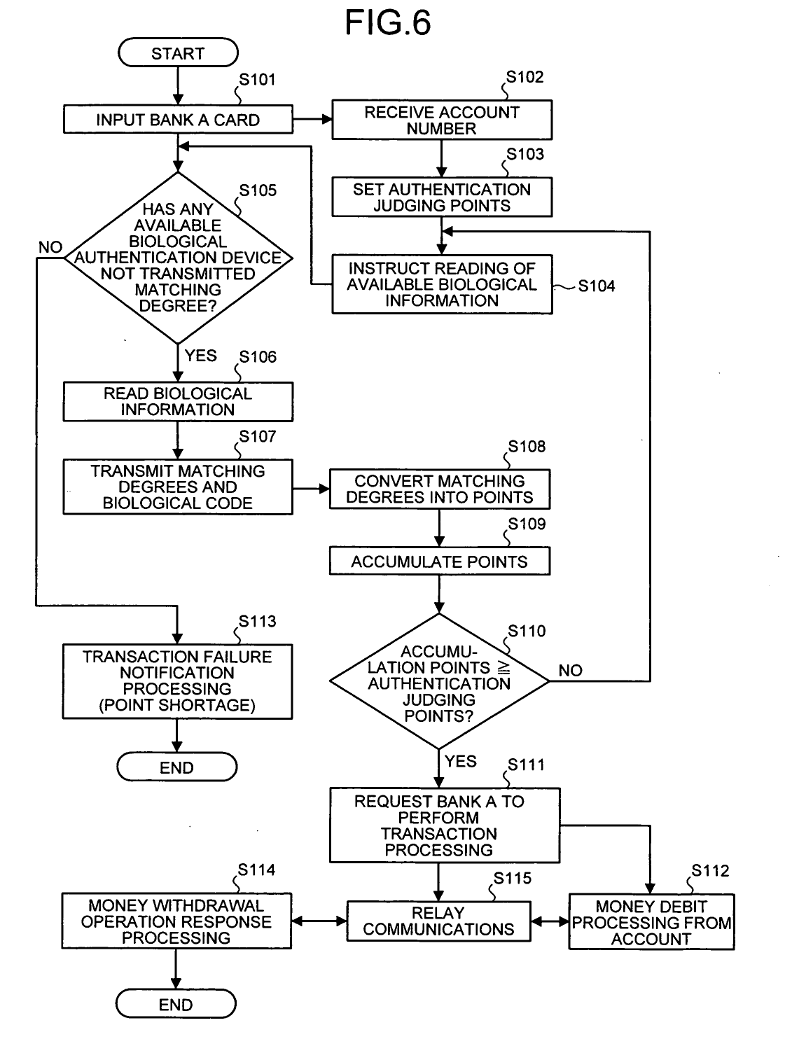

FIG. 6 is a flowchart of processing procedures performed by the financial transaction system. In this example, money is debited from an account of the bank A from the common terminal 40.

In the financial transaction system, a bank A card is input in the common terminal 40 (step S101), the common terminal 40 reads its account number, and transmits it to the user authentication apparatus 100. Then, when the account-number acquiring unit 120 of the user authentication apparatus 100 receives the account number (step S102), the authentication judging criterion for the bank A is set as authentication judging points by referring to the authentication-judging-points storage unit 110 (step S103). Then, the matching-degree acquiring unit 130 instructs the common terminal 40 to read biological information by using biological authentication devices (step S104).

Then, the common terminal 40 receives the biological information reading instruction and judges whether any of the available biological authentication devices have not transmitted a matching degree to the user authentication apparatus 100 (step S105).

As a result, when it is judged that a biological authentication device among the available biological authentication devices has not transmitted a matching degree to the user authentication apparatus 100, biological information is read by using any of the biological authentication devices (step S106), and the matching degree with the user biological information stored in the cash card is transmitted to the user authentication apparatus 100 together with the biological code of the biological authentication device (step S107).

Then, the matching-degree acquiring unit 130 of the user authentication apparatus 100 receives the matching degree and the biological code and delivers these to the point converter 150, and the point converter 150 converts the matching degree into points by referring to the converted-points storage unit 140 (step S108).

Then, the accumulation-points judging unit 160 receives the points from the point converter 150 and accumulates points (step S109), and judges whether the accumulation points are equal to or more than the authentication judging points (step S110). As a result, when the accumulation points are not equal to or more than the authentication judging points, the process returns to step S104 and the common terminal 40 is instructed to read another type of biological information.

On the other hand, when the accumulation points are equal to or more than the authentication judging points, this indicates a success of user authentication. Accordingly, the transaction request unit 170 requests the bank A center 50 to perform transaction processing (step S111), and the transaction relay unit 180 relays communications between money debit processing in the bank A center 50 (step S112) and money withdrawing operation response processing (step S114) in the common terminal 40 (step S115).

When the available biological authentication devices do not include a biological authentication device that has not transmitted a matching degree to the user authentication apparatus 100 (step S105=No), the points do not reach the authentication judging points, and this indicates a user authentication failure. In this case, the common terminal 40 notifies the user of the transaction failure (step S113).

Thus, the point converter 150 converts the matching degrees into points and the accumulation-points judging unit 160 accumulates points and performs authentication by comparing the accumulation points with the authentication judging points, whereby proper authentication judgement can be made even when a user uses a biological authentication device of a biological authentication method that is not employed by the transacting financial institution.

An example in which money is debited from an account of the bank A from the common terminal 40 is explained above, however, the same processing is possible to transact with another financial institution from another terminal.

In FIG. 6, when the available biological authentication devices do not include a biological authentication device that has not transmitted a matching degree to the user authentication apparatus 100, the points do not reach the authentication judging points, the common terminal 40 judges a user authentication failure and notifies the user of the user authentication failure. However, instead of immediately judging the failure transaction, re-reading of the biological information is also possible. Processing to re-read the biological information is explained as follows.

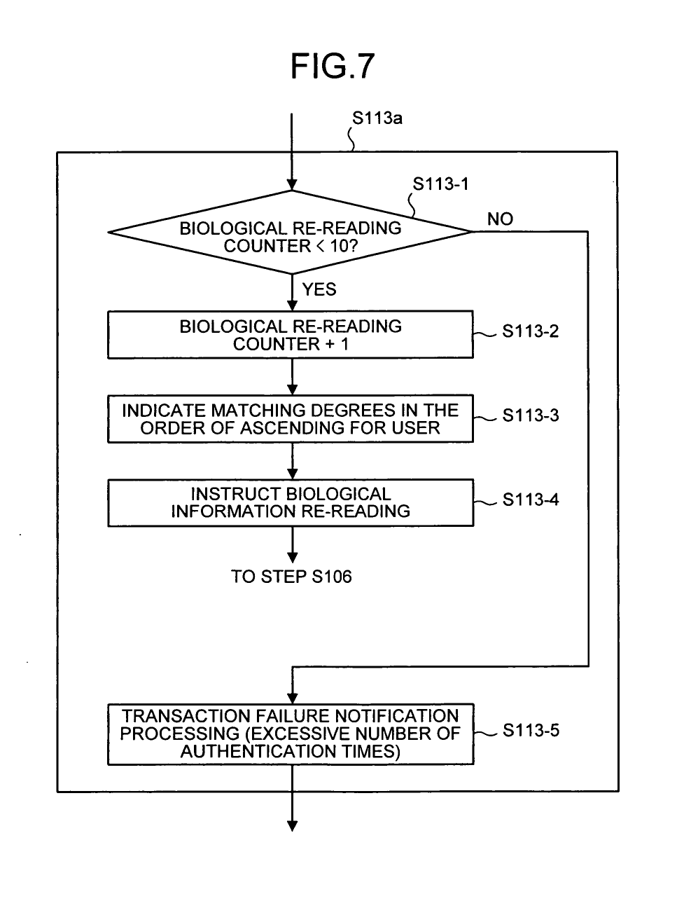

FIG. 7 is a flowchart of a substitute processing of transaction failure notification processing due to a point shortage. The substitute processing (step S113a) is performed instead of step S113 of FIG. 6.

As shown in FIG. 7, in the substitute processing, the common terminal 40 judges whether a biological re-reading counter is less than 10 (step S113-1). Herein, the biological re-reading counter is a counter to count the number of times of re-reading, and its initial count is set to 0.

When the biological re-reading counter is less than 10, that is, the counter does not reach an upper limit of the re-reading number of times set to 10, the biological re-reading counter is incremented by 1 (step S113-2), biological authentication devices are displayed in order of ascending matching degrees for the user (step S113-3), and a biological information re-reading operation is instructed (step S113-4). Then, the process shifts to step S106 of FIG. 6 and is continued.

On the other hand, when the biological re-reading counter is not less than 10, that is, re-reading is performed 10 times, as the re-reading upper limit of times, this indicates exceeding of the upper limit of the number of authentication times, so that transaction failure notification processing is performed (step S113-5).

Thus, by enabling re-reading of biological information, an opportunity for re-authentication can be given to a user when biological information is not correctly read due to an operation failure in the biological authentication device made by the user.

In FIG. 6, withdrawal of money from an account of the bank A is explained, however, in some cases, the user wants to transact not only with the bank A but also with another financial institution, simultaneously. Therefore, transaction with a plurality of companies is explained.

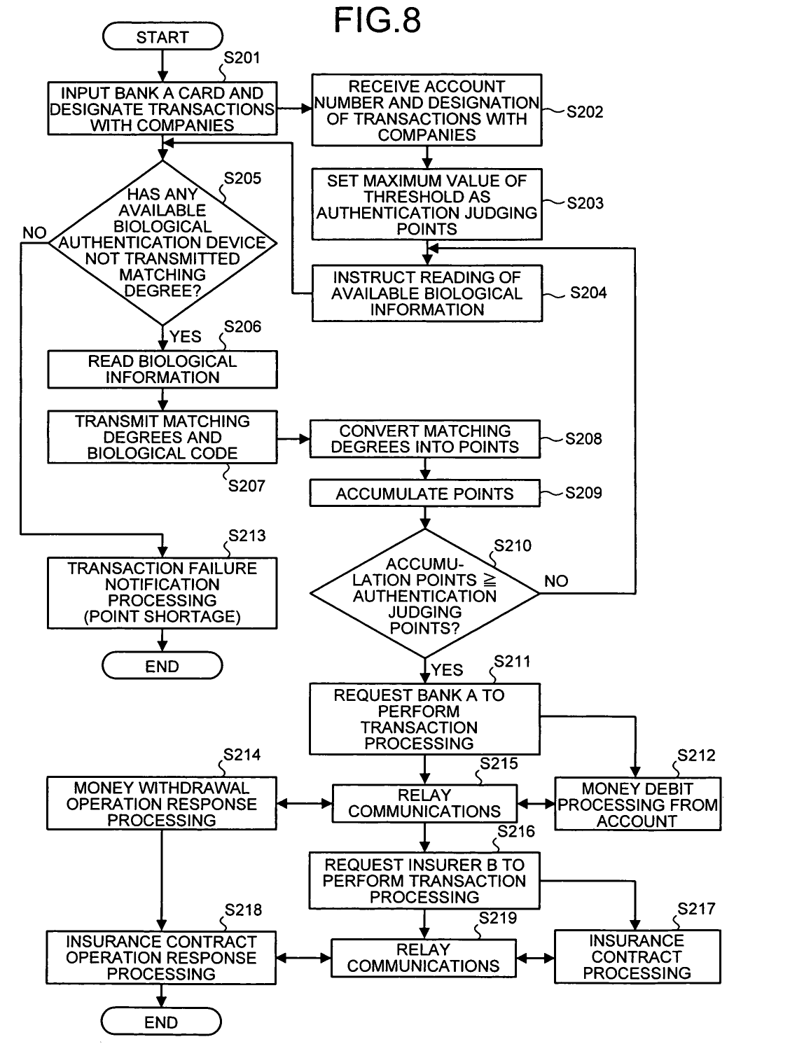

FIG. 8 is a flowchart of processing procedures performed by the financial transaction system according to the first embodiment when a user transacts with a plurality of companies at a time. Herein, explanation is given by assuming the user withdraws money from an account of the bank A and successively carries out a contract with the insurer B.

As shown in the figure, in the financial transaction system, the common terminal 40 inputs a bank A card, accepts transactions with the bank A and the insurer B from the user (step S201), and transmits the account number and the designation of transactions with the bank A and the insurer B to the user authentication apparatus 100.

When the account-number acquiring unit 120 of the user authentication apparatus 100 receives the account number and the designation of transactions with the bank A and the insurer B (step S202), it sets a maximum value of authentication judging criteria (thresholds) as authentication judging points by referring to the authentication-judging-points storage unit 110 (step S203). Then, the matching-degree acquiring unit 130 instructs the common terminal 40 to read biological information by using the biological authentication devices (step S204).

Then, the common terminal 40 receives the biological information reading instruction and judges whether any of the available biological authentication devices have not transmitted a matching degree to the user authentication apparatus 100 (step S205).

As a result, when it is judged that a biological authentication device of the available biological authentication devices has not transmitted a matching degree to the user authentication apparatus 100, biological information is read by using any of the biological authentication devices (step S206), and a matching degree with the user biological information stored in the cash card is transmitted to the user authentication apparatus 100 together with a biological code of the biological authentication device (step S207).

Then, the matching-degree acquiring unit 130 of the user authentication apparatus 100 receives the matching degree and the biological code and delivers these to the point converter 150, and the point converter 150 converts the matching degree into points by referring to the converted-points storage unit 140 (step S208).

Then, when the accumulation-points judging unit 160 receives the points from the point converter 150 and accumulates points (step S209), and judges whether the accumulation points are equal to or more than the authentication judging points (step S210). As a result, when the accumulation points are not equal to or more than the authentication judging points, the process returns to step S204, and the common terminal 40 is instructed to read another biological information.

On the other hand, when the accumulation points are equal to or more than the authentication judging points, this indicates a success of user authentication, so that the transaction request unit 170 requests the bank A center 50 perform transaction processing (step S211) and the transaction relay unit 180 relays communications between money debit processing (step S212) in the bank A center 50 and money withdrawal operation response processing (step S214) in the common terminal 40 (step S215).

When the money debit processing is finished, the transaction request unit 170 requests the insurer B center 60 to make a transaction (step S216), and the transaction relay unit 180 relays communications between insurance contract processing (step S217) in the insurer B center 60 and insurance contract operation response processing (step S218) in the common terminal 40 (step S219).

When the available biological authentication devices do not include a biological authentication device that has not transmitted a matching degree to the user authentication apparatus 100 (step S205=No), the points do not reach the authentication judging points and this indicates a user authentication failure, so that the common terminal 40 notifies the user of the transaction failure (step S213).

Thus, by setting the maximum value of authentication judging criteria of a plurality of dealing financial institutions as authentication judging points, authentications for the financial institutions can be performed at a time. Herein, transactions with a plurality of arbitrary financial institutions at a time are explained, and it is also possible that information of group companies belonging to the same group are stored and only transactions with a plurality of group companies are performed at a time.

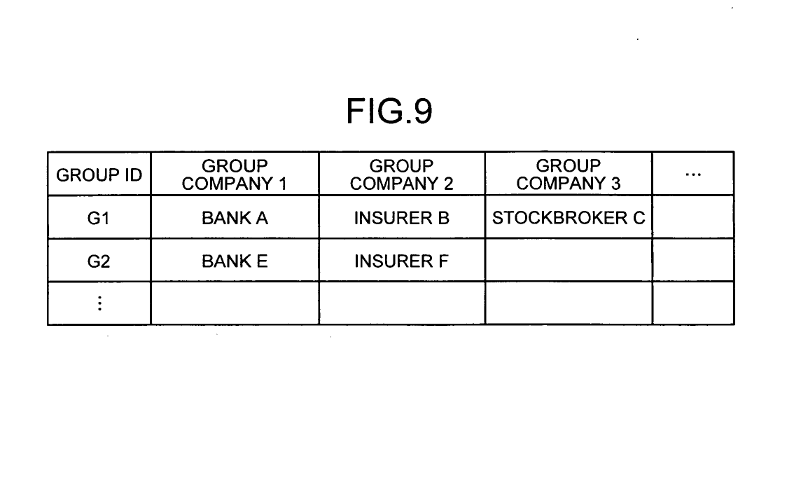

FIG. 9 depicts group company information. The figure indicates that, for example, the bank A, the insurer B, and the stockbroker C are grouped. By storing group company information shown in FIG. 9, the user authentication apparatus 100 judges whether, when a user designates transactions with a plurality of dealing companies, the dealing companies belong to the same group, and permits the transactions at a time only when the dealing companies belong to the same group.

Authentication judgements by using a totaled accumulation points of the points are explained above, however, in addition to the accumulation points, it is also possible that lowest matching degrees are set for each biological authentication device and an authentication failure is judged when any of the matching degrees is equal to or less than the lowest matching degree.

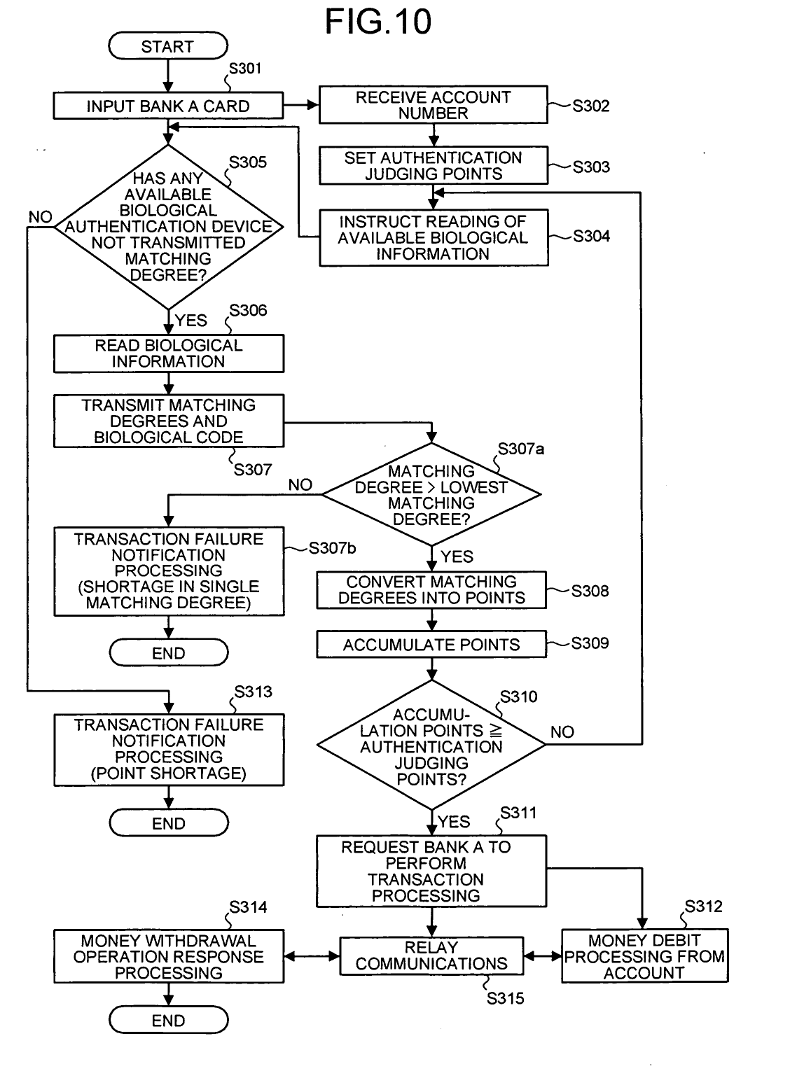

FIG. 10 is a flowchart of processing procedures performed by the financial transaction system according to the first embodiment when lowest matching degrees are set. Comparing FIG. 10 with FIG. 6, the processing of step S301 to step S307 of FIG. 10 corresponds to the processing of step S101 to step S107 of FIG. 6, and the processing of step S308 to step S315 of FIG. 10 corresponds to the processing of step S108 to step S115 of FIG. 6.

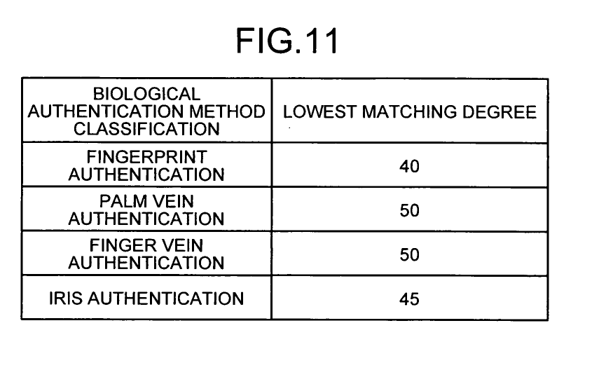

The processing procedures of FIG. 10 are different from the processing procedures of FIG. 6 in that processing (step S307a) of the matching-degree acquiring unit 130 to judge whether matching degrees are more than the lowest matching degrees and transaction failure notification processing (step S307b) of the common terminal 40 to notify a transaction failure due to shortage in a single matching degree are inserted between step S307 and step S308. Herein, the user authentication apparatus 100 stores the lowest matching degrees set for each biological authentication device as lowest matching degree information. FIG. 11 depicts an example of lowest matching degree information. As shown in the figure, in the lowest matching degree information, the biological authentication method classifications are associated with the lowest matching degrees for each biological authentication device.

Thus, lowest matching degrees set for each biological authentication device are stored as lowest matching degree information, and the matching-degree acquiring unit 130 judges whether the matching degrees are more than the lowest matching degrees, whereby inappropriate increase in accumulation points and erroneous success of authentication can be prevented when the number of biological authentication devices set in the terminal is large.

As described above, in the first embodiment, the account-number acquiring unit 120 acquires an account number from a terminal and sets authentication judging points based on a financial institution code contained in the account number, the point converter 150 converts matching degrees acquired by the matching-degree acquiring unit 130 into points, and the accumulation-points judging unit 160 accumulates points and compares the accumulation points with the authentication judging points, whereby performing user authentication, so that user authentication based on a biological authentication method that the user's dealing financial institution does not employ can be performed.

In the first embodiment, user authentication using a biological authentication method employed by other financial institutions is performed while absorbing an accuracy difference among biological authentication methods by converting matching degrees into points, however, it is also possible that respective financial institutions hold thresholds of the biological authentication devices and perform user authentication by using a biological authentication method employed by other financial institutions. Therefore, in a second embodiment, a user authentication apparatus that can perform user authentication by using a biological authentication method employed by other financial institutions by holding thresholds of biological authentication devices in each financial institution is described.

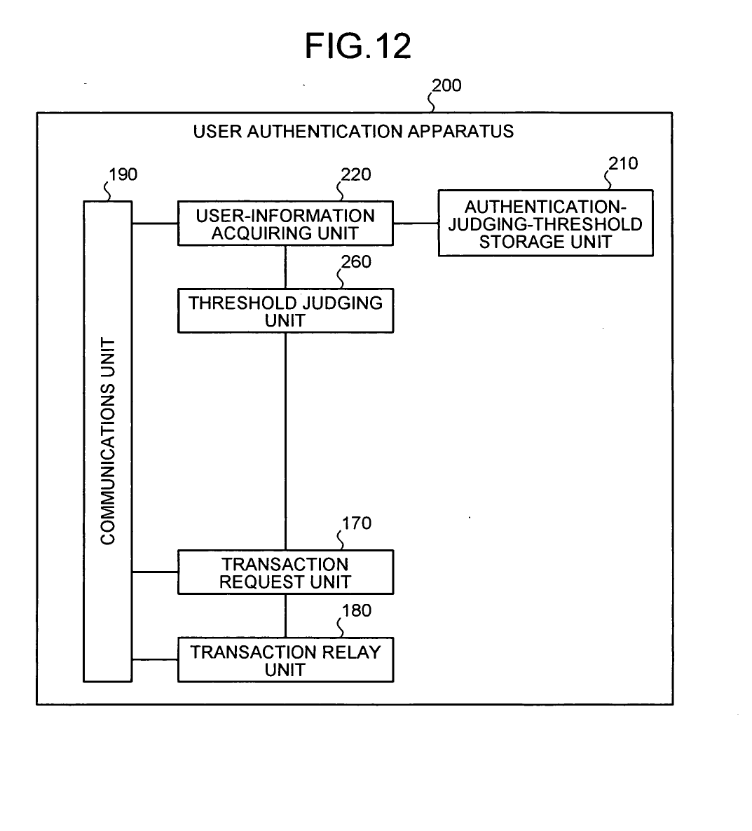

FIG. 12 is a block diagram of a user authentication apparatus 200 according to the second embodiment. Herein, for convenience of explanation, functional units that perform the same functions as the units of FIG. 2 are attached with the same symbols and detailed description thereof is omitted.

As shown in FIG. 12, the user authentication apparatus 200 includes an authentication-judging-threshold storage unit 210, a user-information acquiring unit 220, a threshold judging unit 260, the transaction request unit 170, a transaction relay unit 180, and a communications unit 190.

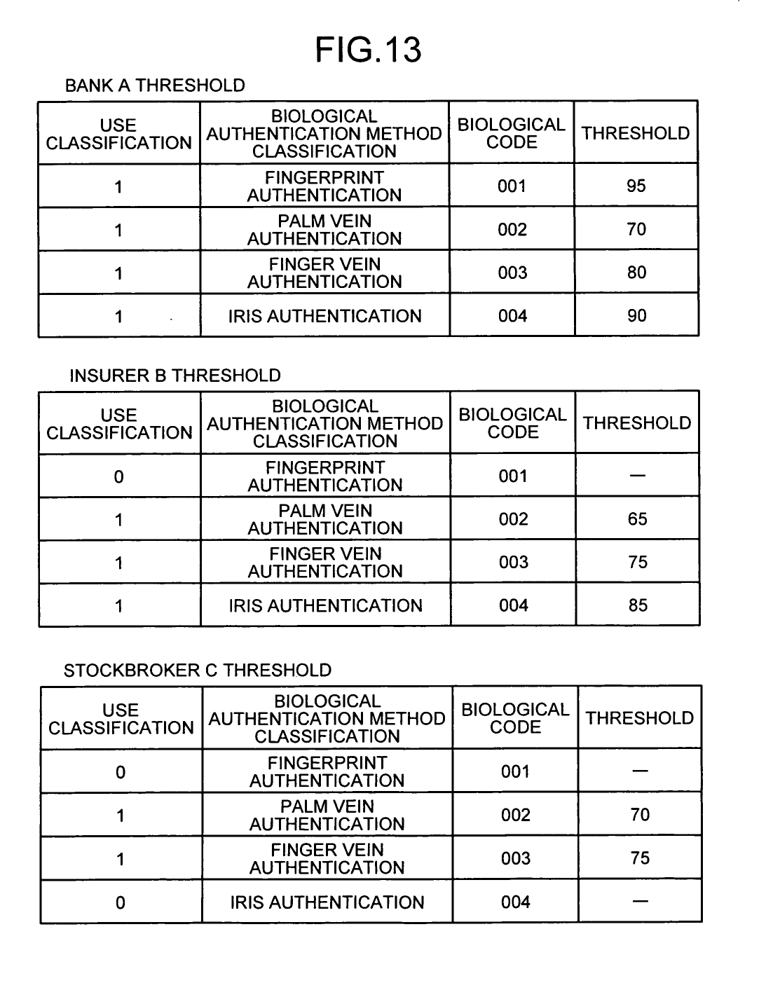

The authentication-judging-threshold storage unit 210 is a storage unit that stores thresholds of biological authentication devices to be used for user authentication for each financial institution. FIG. 13 depicts thresholds that the authentication-judging-threshold storage unit 210 stores for each financial institution.

As shown in the figure, the authentication-judging-threshold storage unit 210 stores a bank A threshold, an insurer B threshold, and a stockbroker C threshold, and each financial institution threshold is composed of a use classification, a biological authentication method classification, a biological code, and a threshold for each biological authentication method. Herein, the use classification is information indicating whether a corresponding biological authentication method is available in each financial institution, and 1 indicates available and 0 indicates unavailable.

The authentication-judging-threshold storage unit 210 stores the use classifications and thresholds for each financial institution, whereby each financial institution can uniquely set a biological authentication method and a threshold to be employed. Each financial institution can perform user authentication by using biological authentication devices provided by other financial institutions by storing thresholds of biological authentication methods that are not employed by the financial institution.

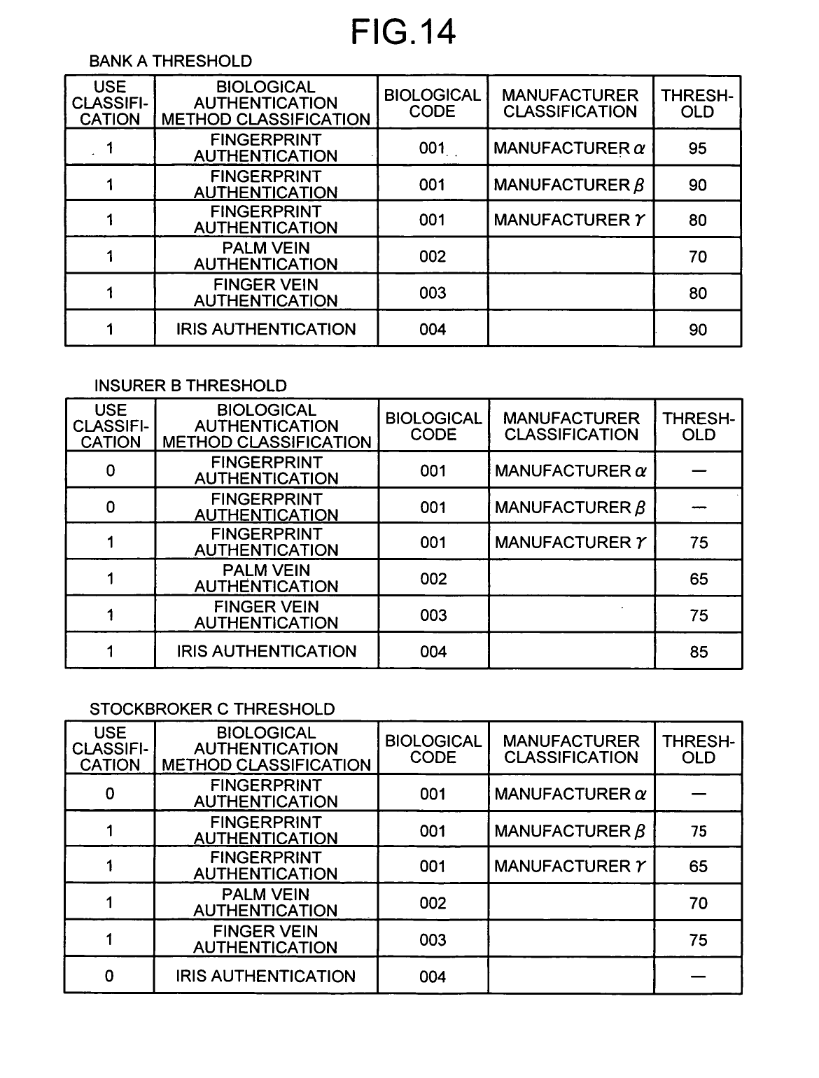

FIG. 14 depicts another example of thresholds that the authentication-judging-threshold storage unit 210 stores for each financial institution. In the example shown in the figure, a manufacturer classification is added to the example of FIG. 13. The manufacturer classification is provided because the accuracy is different among manufacturers that manufacture the biological authentication devices even if their biological authentication methods are same, and the use classification and threshold can be set differently among the manufacturers.

The user-information acquiring unit 220 acquires user information transmitted from a terminal, and in detail, it acquires information such as an account number, a biological code, and a matching degree as user information. The user-information acquiring unit 220 reads a threshold to be used for authentication from the authentication-judging-threshold storage unit 210 based on a financial institution code and the biological code contained in the account number and delivers it to the threshold judging unit 260 together with the matching degree.

The threshold judging unit 260 receives the matching degree and the threshold from the user-information acquiring unit 220 and makes authentication judgement by comparing these, and when authentication is successful, the threshold judging unit instructs the transaction request unit 170 to request a corresponding financial institution to transact, and when authentication has failed, notifies the transaction failure to the terminal.

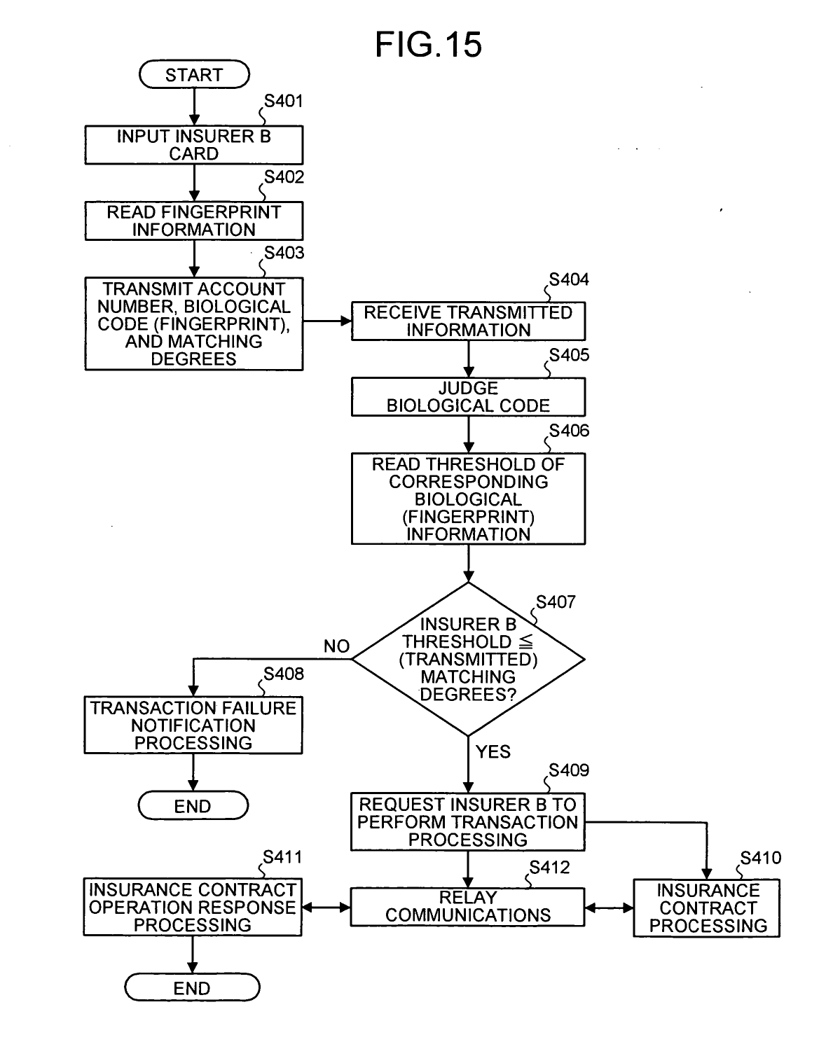

Next, processing procedures of the financial transaction system according to the second embodiment are explained. FIG. 15 is a flowchart of processing procedures performed by the financial transaction system according to the second embodiment. Herein, explanation is given by assuming a contract is carried out with the insurer B from the bank A terminal 10.

As shown in the figure, in the financial transaction system, the bank A terminal 10 inputs an insurer B card (step S401) and reads an account number. The bank A terminal 10 reads fingerprint information of a user from a fingerprint authentication device 11 (step S402), compares this with user fingerprint information stored in the insurer B card, and transmits a matching degree to the user authentication apparatus 200 together with the account number and a fingerprint authentication biological code.

Then, the user-information acquiring unit 220 of the user authentication apparatus 200 receives the transmitted information (step S404), judges the biological code (step S405), reads a threshold from the authentication-judging-threshold storage unit 210 based on the judged biological code (step S406), and delivers the read threshold to the threshold judging unit 260 together with the matching degrees.

The threshold judging unit 260 judges whether the matching degrees are equal to or more than the threshold (step S407), and when the matching degrees are not equal to or more than the threshold, the threshold judging unit transmits transaction failure notification to the bank A terminal 10, and the bank A terminal 10 performs transaction failure nonfiction processing due to the matching degree shortage (step S408).

On the other hand, when the matching degree is equal to or more than the threshold, this indicates a success of user authentication, so that the transaction request unit 170 requests the insurer B center 60 to perform transaction processing (step S409), and the transaction relay unit 180 relays communications between insurance contract processing (step S410) in the insurer B center 60 and insurance contract operation response processing (step S411) in the bank A terminal 10 (step S412).

As described above, in the second embodiment, a threshold is read from the authentication-judging-threshold storage unit 210 based on an account number and a biological code received by the user-information acquiring unit 220 and delivered to the threshold judging unit 260 together with matching degrees, and the threshold judging unit 260 compares the matching degrees and the threshold to perform authentication, whereby proper authentication judgement can be made even when the user uses a biological authentication device of a biological authentication method that the dealing financial institution does not employ.

In the first and the second embodiments, for convenience of explanation, the user authentication apparatuses are connected to the bank A center 50, the insurer B center 60, and the stockbroker C center 70 via the network 80 and connected to the bank A terminal 10, the insurer B terminal 20, and the stockbroker C terminal 30, and the common terminal 40 via the network 80, however, the user authentication apparatus 100 can also be connected to other financial institution centers or other financial institution terminals in the same manner.

In the first and the second embodiments, the user authentication apparatuses are connected to the bank A center 50, the insurer B center 60, and the stockbroker C center 70 via the network 80, however, the invention is not limited to this, and it is also allowed that the user authentication apparatus is installed as a part of each financial institution center.

In the first and the second embodiments, transactions with financial institutions are explained, however, the invention is not limited to this, and the invention is also applicable to situations in that a plurality of companies or organizations provide services by using a common terminal or companies or organizations sell products by using a cooperative sales device in the same manner.

According to an aspect of the invention, convenience for the user is increased, and cost and installation space of a common terminal can be reduced.

Further, user authentication is easily performed.

Further, biological authentication using a plurality of biological authentication methods can be performed.

Further, authentication accuracy is improved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for performing user authentication based on biological information for a plurality of organizations, each of the organizations employing at least one biological authentication method with at least one biological authentication device, comprising:
a storage unit that stores thresholds corresponding to the biological authentication methods employed by the organizations;
an acquiring unit that acquires a matching degree between registered biological information of a user and biological information read by a biological authentication device employed by any one of the organizations; and
an authentication unit that performs user authentication based on the threshold stored in the storage unit and the matching degree acquired by the acquiring unit.

2. The apparatus according to claim 1, wherein the storage unit stores a matching degree as a threshold.

3. The apparatus according to claim 1, further comprising a converting unit that converts a matching degree into a point, wherein
the storage unit stores a point as a threshold.

4. The apparatus according to claim 3, wherein
the storage unit stores a total of points of a plurality of biological authentication methods employed by the organizations, and
the converting unit converts a matching degree acquired by the acquiring unit into a point corresponding to a total of points of a plurality of biological authentication methods employed by the organizations.

5. The apparatus according to claim 4, further comprising:
a lowest matching degree storage unit that stores a lowest matching degree necessary for user authentication in each biological authentication method, wherein
the authentication unit judges that user authentication is unsuccessful when a matching degree acquired by the acquiring unit is less than the lowest matching degree of the corresponding biological authentication method.

6. The apparatus according to claim 4, wherein
the acquiring unit re-acquires a matching degree from any of biological authentication devices when a total of points converted from matching degrees of all biological authentication devices available to a user is less than the threshold.

7. The apparatus according to claim 6, wherein
the acquiring unit re-acquires a matching degree from a biological authentication device from which a lowest point is acquired when a total of points converted from matching degrees of all biological authentication devices available to a user is less than the threshold.

8. The apparatus according to claim 1, wherein the authentication unit performs user authentication at a same time for a plurality of organizations by using matching degrees.

9. The apparatus according to claim 8, wherein the authentication unit performs user authentication at a same time for a plurality of organizations only when the organizations belong to a same group.

10. A method of performing user authentication based on biological information for a plurality of organizations, each of the organizations employing at least one biological authentication method with at least one biological authentication device, the method comprising:
storing thresholds corresponding to the biological authentication methods employed by the organizations;
acquiring a matching degree between registered biological information of a user and biological information read by a biological authentication device employed by any one of the organizations; and
performing user authentication based on the threshold stored and the matching degree acquired.
